(19) United States
(12) Patent Application Publication
(10) Pub. No.: US 2019/0168586 A1
(43) Pub. Date: Jun. 6, 2019

(54) ADAPTIVE LIGHT PASSAGE REGION CONTROL

(71) Applicant: Toyota Research Institute, Inc., Los Altos, CA (US)

(72) Inventor: Stephanie Paepcke, Mountain View, CA (US)

(21) Appl. No.: 15/830,517

(22) Filed: Dec. 4, 2017

(51) Int. Cl. B60J 3/04; G06F 3/01; G09G 3/3208; B60N 2/00

(52) U.S. Cl. CPC B60J 3/04; G06F 3/013; G09G 2320/06; B60N 2/002; G09G 3/3208

(57) ABSTRACT

A device and method of adapting light passage for a vehicle window are disclosed. The device and method operate to include sensing a light source external to the vehicle window, the light source operable to affect viewing the external environment. A portion of an adaptive light passage region of the vehicle window is defined relative to a gaze direction of a vehicle occupant, and an opacity level of the portion of the adaptive light passage region is adapted to normalize the intensity of the light source relative to the light magnitude sample data. The light source may be tracked for sustaining the opacity level of the portion of the adaptive light passage region with the gaze direction of the vehicle occupant while the light source exceeds the intensity threshold.

### FIELD

The subject matter described herein relates in general to vehicle occupant vision devices and, more particularly, to the control of an adaptive light passage region of a vehicle window according to an external light source with respect to a gaze direction of a vehicle occupant.

### BACKGROUND

High intensity lights have generally caused a vehicle operator or passenger to have temporary blindness, or affect their ability to view a vehicle environment in low-light conditions. To avoid having their night vision being adversely affected, vehicle operators and/or vehicle occupants may have had to turn their heads away from the road ahead, causing a hopefully shorter interval of taking their attention away from the road, as contrasted for a likely longer period of time to suffer a loss of night vision for a longer period of time, and correspondingly, being able to safely view the road ahead. As a result, either turning their head to avoid a high-intensity light source, such as an oncoming vehicle, or being caught by surprise by a high-intensity light source, such as an oncoming vehicle cresting a hill, may cause a condition for a collision to occur.

Also, at times, high-intensity, pulsing light sources, such as emergency vehicle light sources, have generally served as an operator distraction by the primal desire to see what is happening (such as a vehicle collision, traffic stop, etc.). Again, a vehicle operator's attention is distracted from the primary task of driving, which as a result may lead to a collision with other vehicles.

### SUMMARY

A device and method for adaptive light passage region control are disclosed.

In one implementation, a method of adapting light passage for a vehicle window is disclosed. The method includes sensing a light source external to the vehicle window, the light source operable to affect viewing the external environment. A portion of an adaptive light passage region of the vehicle window is defined relative to a gaze direction of a vehicle occupant, and an opacity level of the portion of the adaptive light passage region is adapted to normalize the intensity of the light source relative to the light magnitude sample data. The light source may be tracked for sustaining the opacity level of the portion of the adaptive light passage region with the gaze direction of the vehicle occupant while the light source exceeds the intensity threshold.

In another implementation, vehicle control unit is disclosed. The vehicle control unit includes a communication interface, a processor, and memory. The processor is communicably coupled to the communication interface, where the communication interface services communication with a vehicle network. The memory is communicably coupled to the processor and storing a light source detection module, a window opacity module, and a transmission module. The light source detection module includes that, when executed by the processor, cause the processor to sense a light source external to the vehicle window, determine an intensity of the light source; and compare the intensity with an intensity threshold. The window opacity module includes instructions that, when executed by the processor, cause the processor to, when the intensity of the light source exceeds the intensity threshold, define an area parameter of a plurality of widow opacity parameters for a portion of an adaptive light passage region of the vehicle window relative to a gaze direction of a vehicle occupant, define an opacity level parameter of the plurality of window opacity parameters for the portion of the adaptive light passage region operable to normalize the intensity of the light source relative to light magnitude sample data, and generate a coordinate parameter of the plurality of window opacity parameters for the portion of the adaptive light passage region operable to track the light source with the portion of the adaptive light passage region relative to the gaze direction of the vehicle occupant. The transmission module includes instructions that, when executed by the processor, cause the processor to format the plurality of window opacity parameters to produce a window opacity command; and transmit the window opacity command for effecting the portion of the adaptive light passage region.

### BRIEF DESCRIPTION OF THE DRAWINGS

The description makes reference to the accompanying drawings wherein like reference numerals refer to like parts throughout the several views, and wherein:

FIG. 1A illustrates a vehicle cabin of a vehicle with an adaptive light passage region for a vehicle window and a vehicle control unit;

FIG. 1B illustrates a vehicle cabin of a vehicle with another example embodiment of an adaptive light passage region for a vehicle window and a vehicle control unit;

FIG. 2 illustrates a block diagram of the vehicle control unit of FIG. 1;

FIG. 3 illustrates a functional block diagram of the vehicle control unit of FIGS. 1 and 2; and

FIG. 4 is an example process to adapt light passage for a vehicle window.

### DETAILED DESCRIPTION

A device and method for an adaptive light passage region of a vehicle window are described herein.

The device and method are operable to adapt light passage of an external light source through a vehicle window to minimize distraction by the external light source. For example, in strong or harsh sunlight conditions, a portion of an adaptive light passage region of the vehicle window is defined relative to a gaze direction of a vehicle occupant. A window opacity parameter of the portion of the adaptive light passage region is adapted to normalize the intensity of the light source, such as the sun, relative to light magnitude sample data for the vehicle window. The light source may be tracked to sustain the window opacity parameter of the portion of the adaptive light passage region with the gaze direction of the vehicle occupant while the light source exceeds an intensity threshold, such as the sun continues to shine through the vehicle window, causing discomfort to the vehicle operator and/or occupant.

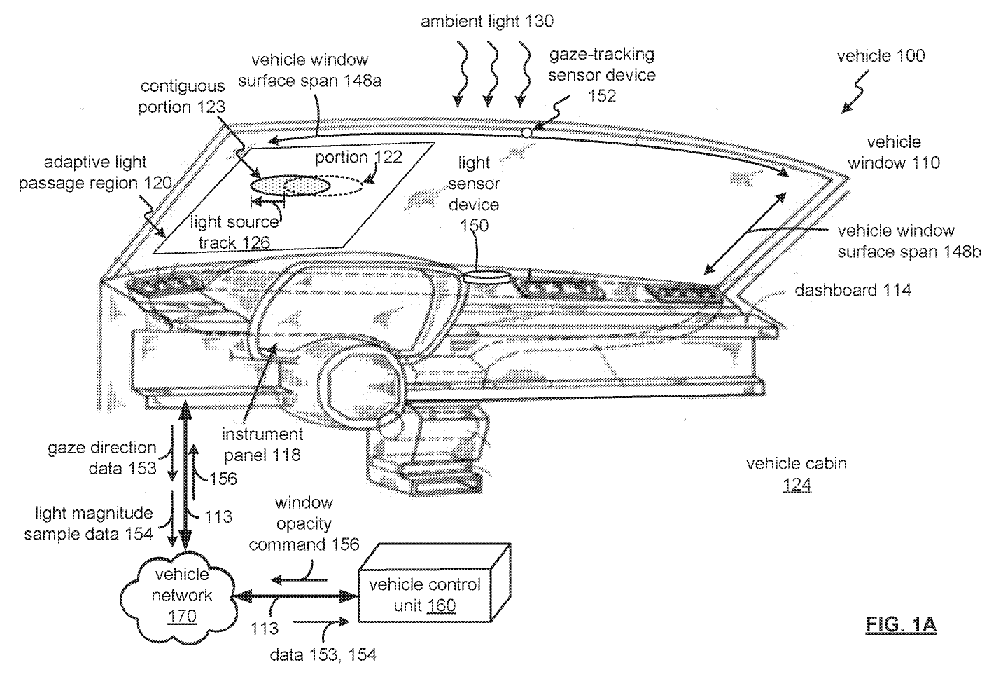

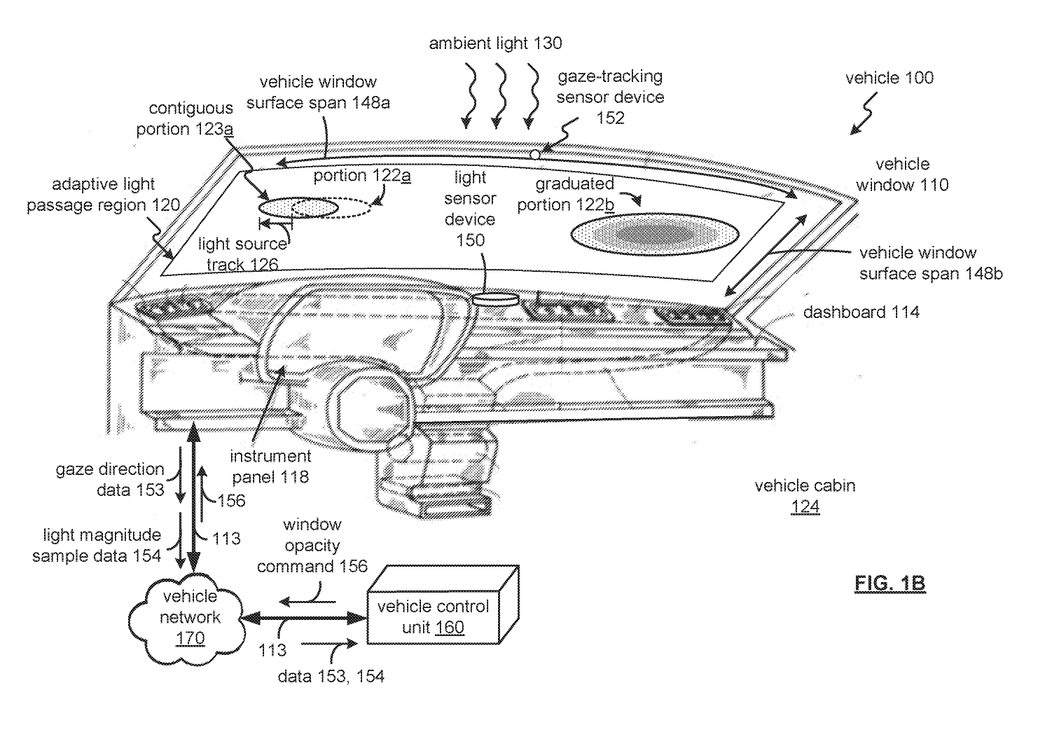

FIG. 1A is an illustration of a vehicle cabin 124 of a vehicle 100, which may include an adaptive light passage region 120 for a vehicle window 110 and a vehicle control unit 160. As may be appreciated, the vehicle 100 may be an electric vehicle (EV), a combustible-fuel/electric hybrid vehicle, and/or a combustible-fuel vehicle, such as an automobile, light truck, cargo transport, or any other passenger or non-passenger vehicle.

The vehicle 100 may include a dashboard 114 positioned towards a front most portion of a vehicle cabin 124. The dashboard 114 extends in the lateral direction between the sides of the vehicle 100. A top surface of the dashboard 114 is located under a vehicle window 110.

An instrument panel 118 may be positioned for viewing by a vehicle operator and/or occupant. Light sensor device 150 may operate to sense ambient light 130 passing through the vehicle window 110 into the vehicle cabin 124. The intensity of the ambient light reaching the vehicle cabin 124 relates to a refractive index of the vehicle window, which may be averaged to assess the amount of ambient light in the vehicle environment.

For adapting light passage, the vehicle window 110 may include an adaptive light passage region 120, which may be responsive to commands generated by the vehicle control unit 160 via a window opacity command 156. The adaptive light passage region 120 may be provided as a display overlay on the interior or exterior of the vehicle window 110, or as a component part of the window structure. As shown, the adaptive light passage region 120 may engage a portion of the vehicle window 110 generally within the field of a vehicle occupant's gaze, though the adaptive light passage region 120 may have a coverage area corresponding to the window surface area, relating to a vehicle window surface span 148 and 148b.

The adaptive light passage region 120 may be transparent in a neutral state, while portions may be responsive to the window opacity command 156. The window opacity command may include window opacity parameter such as an opacity level parameter, an area parameter, a shape parameter, and coordinate parameter related to a portion 122 and/or contiguous portion 124 of the adaptive light passage region 120.

The contiguous portion 124 relates to a light source track 126 such that the portion 122 may sustain the window opacity parameter of the portion 122 of the adaptive light passage region 120 with a gaze direction of a vehicle occupant while the light source exceeds the intensity threshold. The opacity of the portion 122 and/or 123 may also be referred to as an absorption coefficient effected by the opacity level parameter. In this respect, the adaptive light passage region 120 may provide portions 122, 123, etc., that may absorb light from a light source to normalize (or equalize) the intensity of a light source (such as the sun, an oncoming car headlights at night, disruptive flashing emergency vehicle lights, etc.) with respect to the light magnitude sample data 154, which conveys an average intensity of the ambient light 130 via the light sensor device. That is, for normalizing the intensity of the light source as perceived by a vehicle occupant, the light intensity may be adaptively absorbed and/or reflected by an opacity level, such that a fraction of the light source intensity passes to the vehicle cabin 124 through the portion 122 and/or contiguous portion 123.

The portion 122 and/or contiguous portion 123 may be based on gaze direction data 153 of the vehicle operator, in the present example, and captured via the gaze-tracking sensor device 152 (such as a camera, an infrared tracking, a face-tracking algorithm based on camera input, etc.).

Gaze-tracking sensor device 152 may operate to generate gaze direction data 153. Light sensor device 150 may generate light magnitude sample data 154. The gaze direction data 153 and the light magnitude sample data 154 may be conveyed via a vehicle network 170 to control units of the vehicle 100, such as the vehicle control unit 160.

The adaptive light passage region 120 may be provided as an OLED (Organic Light Emitting Diode) display. As may be appreciated, OLED displays may include a flat-light emitting technology, made by placing a series of organic thin films between two conductors providing flexibility and thin construction. The OLED display may operate similar to a display screen, forming colored and/or opaque portions 122 and 123 to filter, diminish and/or normalize (or equalize) an external light source intensity. Other embodiments may include LED, LCD structures reactive to electric actuation.

Further, with respect to a display embodiment, alpha compositing may be operable to capture a live-video stream viewed via the adaptive light passage region 120 to provide virtual application of window opacity for normalizing the intensity of the light source relative to the light magnitude sample data. For example, alpha compositing may operate to combining the portion 122 and/or 123 with a video stream background to create the appearance of partial or full transparency to virtually normalize the light intensity related to a light source. In this respect, a composite display may be generated to combine rendered portions of the adaptive light passage region 120 with live stream of the forward vehicle window perspective. Also, because display materials, such as an OLED display, may be transparent when not active, a vehicle operator may view the driving environment, while the adaptive light passage region 120 may display an alpha compositing video, or video relating to portions that may be aligned with the gaze direction of a vehicle occupant.

The light sensor device 150 may include one element or a plurality of elements in an array configuration for assessing the average ambient light 130 density for the vehicle 100. The sensor device 150 may operate for a sensing region that may include a horizontal vehicle window surface span 148a and a vertical vehicle window surface span 148b. The area of the sensing region may be sized sufficient to determine an intensity threshold, which may be based on a light intensity average for the vehicle 110, a flashing light intensity (such as those of police vehicles, emergency vehicles, etc.).

The vehicle control unit 110 may be operable to sense a light source external to a vehicle window, such as using the light sensor device 150, camera sensor devices of the vehicle 100, etc. Gaze direction data 153 may be generated by a gaze-tracking sensor device 152, which may provide eye-tracking, face tracking, of the vehicle occupant, which may correlate with the adaptive light passage region 120. With respect to movement of a light source, such as an oncoming vehicle relative the vehicle 100, sunlight, emergency vehicle hazard lights, etc.

Though the front window is illustrated in the example of FIG. 1, one or more vehicle windows (e.g., front windshield, side window, etc.) may include an adaptive light passage region for adapting an opacity level parameter to normalize, or in some instances, black-out a view of a collision scene.

Also, a window opacity parameter may be generated for a portion of an adaptive light passage region 120 based on a manual-actuation via a user interface or other suitable manner. In such case, one or more physical or graphical user interface elements (e.g., buttons, switches, etc.) may be provided in the vehicle cabin 124. As another example, actuation may occur upon detection of a trigger condition.

For instance, the vehicle control unit 160 can be configured to detect one or more driver conditions indicative of difficulty seeing due to sunlight, oncoming vehicle headlights, etc., such as facial recognition of vehicle operator expressions such as squinting, weight-shift to shield from the light source, eye gaze, etc. Other triggers may include the addition of sunglasses or shades their eyes with their hand, indicating a sunrise or sunset condition. Thus, the vehicle 100 may include various biometric sensors to “read” the presence of a high-intensity light source. Another example of a trigger condition may include a vehicle cabin 124 condition such as a sun visor is deployed.

Also, with respect to facial recognition, an interior camera sensor device may capture image data of respective vehicle passengers facial expressions, and based on image recognition engines and/or machine learning techniques, a determination for issuing a respective window opacity command 156 may be generated and transmitted to generate a portion 122, or a plurality of portions 122 for respective vehicle passengers.

FIG. 1B is an illustration of another embodiment of a vehicle cabin 124 of a vehicle 100, which may include an adaptive light passage region 120 for a vehicle window 110 and a vehicle control unit 160.

The adaptive light passage region 120 may extend across the vehicle window surface span 148a of the vehicle window 110. The adaptive light passage region 120 may provide portions 122a and 122b responsive to the window opacity command 156 for each of a front driver position and a front passenger position.

Further, an additional adaptive light passage region 120 may be presented on a rear driver-side and passenger-side window to further provide portions responsive to the window opacity command 156.

The portion 122a and/or contiguous portion 123a may be based on gaze direction data 153 of the vehicle operator, in the present example, and captured via the gaze-tracking sensor device 152 (such as a camera, an infrared tracking, a face-tracking algorithm based on camera input, etc.). The graduated portion 122b may also be based on gaze direction data 153 of the vehicle passenger, in the present example, and captured via the gaze-tracking sensor device 152. As indicated, a portion 122a may track a driver gaze to generate a contiguous portion 123a. Other variations of portions may be implemented, such as a graduated portion 122b that provides a lower opacity level near a center, and gradually increases outward to allow additional ambient light 130 in to the vehicle cabin 134, and for the comfort of the passenger. Moreover, the adaptive light passage region 120 may alter an opacity level across the region 120, while providing reduced opacity (and light filtering) aligned with a gaze of a driver and/or passenger.

Gaze-tracking sensor device 152 may operate to generate gaze direction data 153, which allows the portion 122a and 122b to track a passenger gaze. Light sensor device 150 may generate light magnitude sample data 154. The gaze direction data 153 and the light magnitude sample data 154 may be conveyed via a vehicle network 170 to control units of the vehicle 100, such as the vehicle control unit 160.

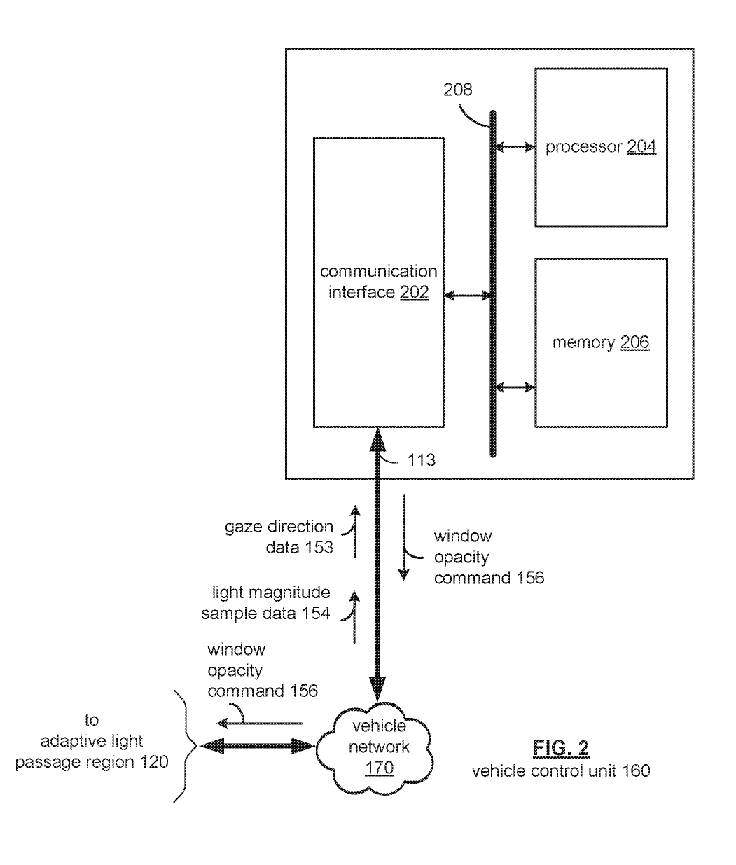

FIG. 2 illustrates a block diagram of a vehicle control unit 110 in the context of a vehicle 100. While the vehicle control unit 110 is depicted in abstract with other vehicular components, the vehicle control unit 110 may be combined with the system components of the vehicle 100 (see FIG. 1).

The vehicle control unit 110 may operate the adaptive light passage region 120 to define portions 122 and 123 (FIG. 1) responsive to a window opacity command 156. The vehicle control unit 110 may communicate with the adaptive light passage region 120 via a communication path 213.

Trigger condition data may be provided to the vehicle control unit 160 from internal and/or external vehicle sensors. For example, the condition data may include gaze direction data 153 via a gaze tracking sensor device (for eye-tracking, face-tracking, etc.), light magnitude sample data 154 via a light sensor device operable to detect an intensity of a light source, as well as provide an intensity threshold for providing a window opacity parameter via a window opacity command 156.

The internal vehicle environment may be recognized based on direction of the vehicle operator's gaze via gaze direction data 153 (such as to the side of the vehicle that may indicate avoiding an intense light source, or gazing in a distracted direction towards a likely hazard or vehicle collision, etc.). In addition, other biometric sensing may be implemented, such as sensing skin temperature, coloration etc. (indicating the emotional state of the vehicle user, such as calm, frustrated, angry, etc.), etc.

By processing sensor data such as the gaze direction data 153 and the light magnitude sample data 154, the vehicle control unit 160 may operate to produce a window opacity command 156 for transmission to the adaptive light passage region 120 and/or intermediate vehicle control units to adapt a window opacity parameter of the portion of the adaptive light passage region via a window opacity command 156 to normalize the intensity of a light source relative to the light magnitude sample data 154. The portion may be defined via the window opacity command 156 as relating to an opacity (or absorption) level parameter, an area size parameter, a relative placement parameter, etc.

As may be appreciated, the communication path 213 of the vehicle network 170 may be formed a medium suitable for transmitting a signal such as, for example, conductive wires, conductive traces, optical waveguides, or the like. Moreover, the communication path 213 can be formed from a combination of mediums capable of transmitting signals. In one embodiment, the communication path 213 may include a combination of conductive traces, conductive wires, connectors, and buses that cooperate to permit the transmission of electrical data signals to components such as processors, memories, sensors, input devices, output devices, and communication devices.

Accordingly, the communication path 213 may be provided by a vehicle bus, or combinations thereof, such as for example, a Body Electronic Area Network (BEAN), a Controller Area Network (CAN) bus configuration, an Audio Visual Communication-Local Area Network (AVC-LAN) configuration, a Local Interconnect Network (LIN) configuration, a Vehicle Area Network (VAN) bus, a vehicle Ethernet LAN, a vehicle wireless LAN and/or other combinations of additional communication-system architectures to provide communications between devices and systems of the vehicle 100.

The term “signal” relates to a waveform (e.g., electrical, optical, magnetic, mechanical or electromagnetic), such as DC, AC, sinusoidal-wave, triangular-wave, square-wave, vibration, and the like, capable of traveling through at least some of the mediums described herein.

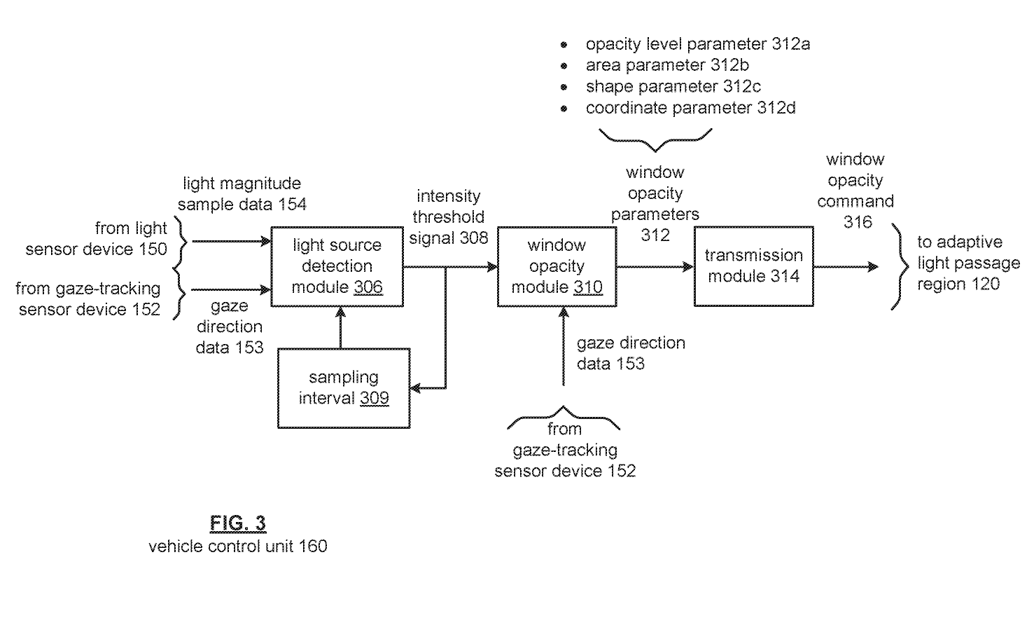

FIG. 3 illustrates a functional block diagram of a vehicle control unit 160. The vehicle control unit may include a light source module 306, a window opacity module 310, and a transmission module 314.

In operation, the memory of the vehicle control unit 160 may be communicably coupled to the processor 204 and to the light sensor device 150 and gaze-tracking sensor device 152 (FIG. 1) to receive light magnitude sample data 154 and gaze direction data 153.

The memory 206 stores the light source module 306 including instructions that when executed cause the processor 304 to sense a light source external to a vehicle window via light magnitude sample data 154 from the light sensor device 150. The light source detection module 306 may also operate to detect the presence of a light source external to a vehicle window via biometric indicators from a vehicle occupant, such as via gaze direction data 153 from the gaze-tracking sensor device 152.

For instance, the vehicle control unit 160 may detect one or more vehicle occupant biometric conditions indicative of difficulty seeing due to sunlight, oncoming vehicle headlights, etc. Biometric information may include facial recognition of vehicle operator expressions such as squinting, weight-shift to shield from the light source, eye gaze, etc. Thus, the vehicle 100 may include various biometric reactions sensed by biometric sensor devices to “read” the presence of a high-intensity light source, which may be taken as having an excessive intensity because of an occupant's response to a light source (such as a resulting discomfort and attempts to minimize the effect on vision).

As may be appreciated, the light source module 306 may operate to average the light magnitude sample data 154 for a predetermined time period to generate an intensity threshold, as well as sense a spike in light intensity that may relate to a light source, such as oncoming vehicle lights, sun glare, etc.

The light source detection module 306 may determine an intensity of the light source, and compare the intensity with an intensity threshold. For example, based on light magnitude sample data 154, when the intensity of a light source exceeds a light intensity average for the vehicle window (that is, the pre-existing level of light intensity), or the light source is a flashing light intensity that is periodic in nature), or may not sustain a light intensity, the receipt of biometric data, such as gaze direction data 153, indicative of vehicle occupant discomfort.

When the intensity of a light source exceeds the intensity threshold, the light source detection module 306 may generate an intensity threshold signal 308, which may be received by the window opacity module 310. Sampling interval 309 may operate to prompt the light source detection module 3006 to repeatedly sample the light magnitude sample data 154 and/or the gaze direction data 153 for movement of a light source, and to provide tracking of the light source to sustain a portion of the adaptive light passage region 120 to mitigate vehicle operator and/or occupant discomfort.

The memory 206 stores the window opacity module 310 including instructions that when executed, cause the processor 304 to define a portion of an adaptive light passage region of the vehicle window relative via a plurality of window opacity parameters 312 and a gaze direction of a vehicle occupant based on gaze direction data 153.

In operation, the window opacity module 310 receives the intensity threshold signal 308 and defines therefrom an area parameter 312a of a plurality of widow opacity parameters 312 for a portion of an adaptive light passage region of the vehicle window relative to a gaze direction of a vehicle occupant. The area parameter 312a may operate to define a sufficient area to “block” the intensity of a light source to alleviate vehicle operator and/or occupant discomfort from the light intensity. As may appreciated, a shape parameter 312b of the plurality of window opacity parameters 312 may define the shape of the portion, such as geometric shapes including squares, rectangles, ovals, circular, etc., as well as other whimsical shapes, such as virtual sunglasses, hat profiles, etc.

The window opacity module 310 may further operate to define from the intensity threshold signal 308 an opacity level parameter 312c of the plurality of window opacity parameters 312 for the portion of the adaptive light passage region. The opacity level parameter 312c may define an opacity (or absorption) level operable to normalize the intensity of the light source relative to light magnitude sample data for the remaining portion of the adaptive light passage region and/or the vehicle window.

The window opacity module 310 generates a coordinate parameter 312d of the plurality of window opacity parameters 312 for the portion of the adaptive light passage region operable to track the light source with the portion of the adaptive light passage region relative to the gaze direction of the vehicle occupant. In this respect, the gaze direction data 153 from the gaze-tracking sensor device 152 provides the coordinate 312d to normalize the view for the vehicle operator and/or occupant.

The memory 206 stores the transmission module 314 including instructions that when executed, cause the processor 304 to receive the plurality of window opacity parameters 312, and produce a window opacity command 316. The window opacity command 316 may be formatted, or encapsulated, for effecting the portion of the adaptive light passage region based on the plurality of window opacity parameters 312.

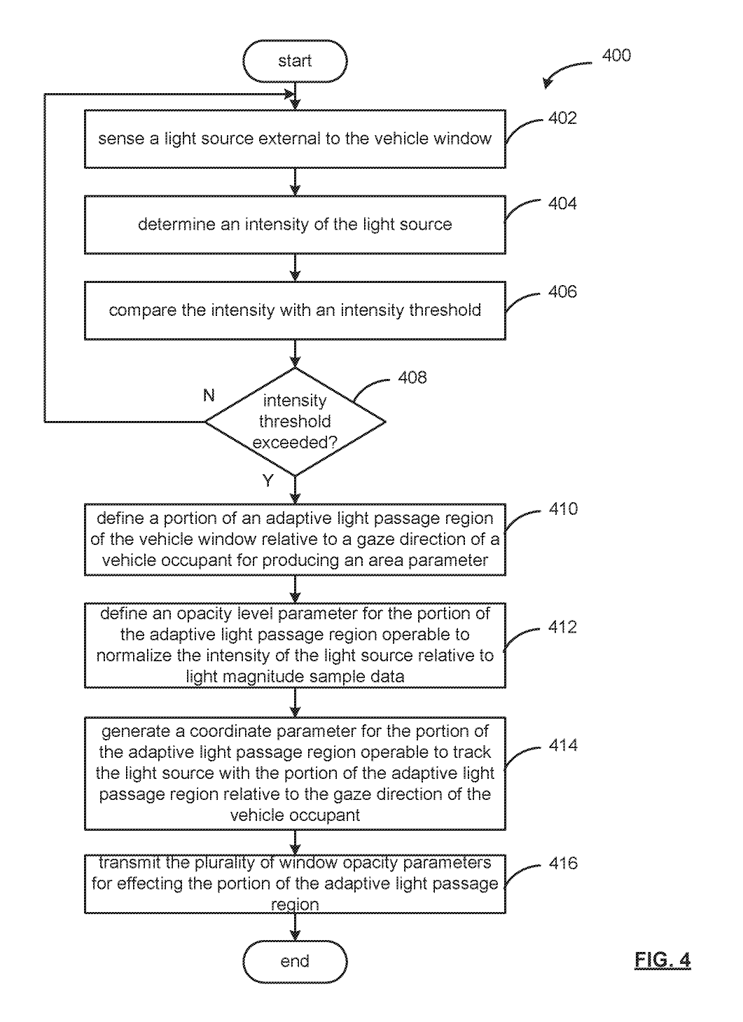

FIG. 4 is an example process 400 of adapting light passage for a vehicle window. At operation 402, a light source external to a vehicle window may be sensed via a light sensor device, as well may be sensed based on biometric indicators of a vehicle occupant, such as via gaze direction data from the gaze-tracking sensor device.

For sensing the light source, vehicle sensors may detect one or more vehicle occupant biometric conditions indicative of difficulty seeing due to sunlight, oncoming vehicle headlights, etc. Biometric information may include facial recognition of vehicle operator expressions such as squinting, weight-shift to shield from the light source, eye gaze, etc., that may evidence resulting operator and/or occupant discomfort and their attempts to mitigate the effect on their eye sight.

At operation 404, an intensity of the light source may be determined, and at operation 406, compared to an average of light magnitude sample data over a predetermined time period that may provide an intensity threshold. The intensity of the light source may be based on a “spike” in a light magnitude sample light intensity, because sharp magnitude transitions may operate to indicate the occurrence of a light source, such as oncoming vehicle lights, sun glare, etc.

When the intensity of a light source exceeds the intensity threshold at operation 408, the process proceeds to operation 410. The intensity of the light source may be considered to exceed an intensity threshold when exceeding a pre-existing light intensity average, or the light source may be periodic, indicating a flashing light intensity, such as emergency vehicles. Biometric data may also indicate that a light source exceeds an intensity threshold when the biometric data may be indicative of vehicle occupant discomfort.

When the intensity of a light source exceeds the intensity threshold, the light source detection module 306 may generate an intensity threshold signal 308, which may be received by the window opacity module 310. Sampling interval 309 may operate to prompt the light source detection module 3006 to repeatedly sample the light magnitude sample data 154 and/or the gaze direction data 153 for movement of a light source, and to provide tracking of the light source to sustain a portion of the adaptive light passage region 120 to mitigate vehicle operator and/or occupant discomfort.

At operation 410, an area parameter may be defined for a portion of the adaptive light passage region of the vehicle window relative to a gaze direction of a vehicle occupant for producing an area parameter. The area parameter may operate to define a sufficient area to “block” the intensity of a light source to alleviate vehicle operator and/or occupant discomfort from the light intensity. As may appreciated, a shape parameter may further define an outer boundary of the area parameter, such as to form geometric shapes including squares, rectangles, ovals, circular, etc., as well as other shapes, such as virtual sunglasses, hat profiles, etc.

At operation 412, an opacity level parameter of a plurality of window opacity parameters may be defined for the portion of the adaptive light passage region. The opacity level parameter may define an opacity (or absorption) level operable to normalize the intensity of the light source relative to light magnitude sample data for the remaining portion of the adaptive light passage region and/or the vehicle window.

To place the portion within the adaptive light passage region, at operation a coordinate parameter maybe generated for the portion of the adaptive light passage region. As the position of the light source may change over time, the operation coordinate parameter may be updated to track the light source with the portion in conjunction with the gaze direction a vehicle occupant. In this respect, the gaze direction data from a gaze-tracking sensor device (such as an eye-tracking sensor device or face-tracking sensor device) may generate the coordinate parameter for placing the portion for normalizing the operator's and/or occupant's view.

At operation 416, a plurality of window opacity parameters (such as the area parameter, the shape parameter (as desired), the opacity level parameter, and coordinate parameter) may be formatted and/or encapsulated based on the requirements a vehicle network for effecting the portion of the adaptive light passage region.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-54, but the embodiments are not limited to the illustrated structure or application. As one of ordinary skill in the art may appreciate, the term “substantially” or “approximately,” as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items range from a difference of a few percent to magnitude differences. As one of ordinary skill in the art may further appreciate, the term “coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “coupled.”

As one of ordinary skill in the art may further appreciate, the term “coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “coupled.”

As the term “module” is used in the description of the drawings, a module includes a functional block that is implemented in hardware, software, and/or firmware that performs one or more functions such as the processing of an input signal to produce an output signal. As used herein, a module may contain submodules that themselves are modules.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage medium, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium.

The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. A method of adapting light passage for a vehicle window, the method comprising:
sensing a light source external to the vehicle window;
capturing video of a forward perspective of the vehicle window;
determining an intensity of the light source;
comparing the intensity with an intensity threshold;
when the intensity of the light source exceeds the intensity threshold:
defining a portion of an adaptive light passage region of the vehicle window relative to a gaze direction of a vehicle occupant for producing an area parameter of a plurality of window opacity parameters;
determining a portion of the video aligned with the gaze direction of the vehicle occupant; and
displaying the portion of the video aligned with the gaze direction of the vehicle occupant in the portion of the adaptive light passage region of the vehicle window when the light source exceeds the intensity threshold while one or more other portions of the adaptive light passage region of the vehicle window remain transparent, wherein the portion of the adaptive light passage region is transparent when the light source does not exceed the intensity threshold.

2. The method of claim 1, wherein the intensity threshold comprises:
a flashing light intensity.

3. The method of claim 1 wherein the light source comprises at least one of:
a light source by an oncoming vehicle;
a light source by an emergency vehicle; and
an environmental light source.

4. The method of claim 1 wherein the sensing the light source external to the vehicle window comprises:
sensing a biometric reaction by the vehicle occupant responsive to a light source.

5. The method of claim 1 wherein the direction of a vehicle occupant gaze is based on at least one of:
a vehicle seat sensor device to indicate the position of the occupant relative to the vehicle window.

6. (canceled)

7. (canceled)

8. A method of adapting light passage for a vehicle window, the method comprising:
sensing a light source external to the vehicle window, the light source operable to affect viewing the external environment;
capturing video of a forward perspective of the vehicle window;
defining a portion of an adaptive light passage region of the vehicle window relative to a gaze direction of a vehicle occupant;
determining a portion of the video aligned with the gaze direction of the vehicle occupant; and
displaying the portion of the video aligned with the gaze direction of the vehicle occupant in the portion of the adaptive light passage region of the vehicle window when the light source exceeds an intensity threshold while one or more other portions of the adaptive light passage region of the vehicle window remain transparent, wherein the portion of the adaptive light passage region is transparent when the light source does not exceed the intensity threshold.

9. The method of claim 8 wherein the light source comprises at least one of:
a light source by an oncoming vehicle;
a light source by an emergency vehicle; and
an environmental light source.

10. The method of claim 8, wherein the sensing the light source external to the vehicle window comprises:
sensing a biometric reaction by the vehicle occupant responsive to a light source.

11. The method of claim 8 wherein the direction of a vehicle occupant gaze is based on:
a vehicle seat sensor device to indicate the position of the occupant relative to the vehicle window.

12. (canceled)

13. (canceled)

14. A vehicle control unit comprising:
a communication interface to service communication with a vehicle network;
a processor communicably coupled to the communication interface; and
memory communicably coupled to the processor and storing:
a light source detection module including instructions that, when executed by the processor, cause the processor to:
sense a light source external to a vehicle window;
capture video of a forward perspective of the vehicle window;
determine an intensity of the light source; and
compare the intensity with an intensity threshold; and
a window opacity module including instructions that, when executed by the processor, cause the processor to, when the intensity of the light source exceeds the intensity threshold:
define a portion of an adaptive light passage region of the vehicle window relative to a gaze direction of a vehicle occupant for producing an area parameter of a plurality of window opacity parameters;
determine a portion of the video aligned with the gaze direction of the vehicle occupant; and
display the portion of the video aligned with the gaze direction of the vehicle occupant in the portion of the adaptive light passage region of the vehicle window when the light source exceeds the intensity threshold while one or more other portions of the adaptive light passage region of the vehicle window remain transparent, wherein the portion of the adaptive light passage region is transparent when the light source does not exceed the intensity threshold.

15. The vehicle control unit of claim 14, wherein the intensity threshold comprises:
a flashing light intensity.

16. The vehicle control unit of claim 14 wherein the light source comprises at least one of:
a light source by an oncoming vehicle;
a light source by an emergency vehicle; and
an environmental light source.

17. The vehicle control unit of claim 14 wherein the sensing the light source external to the vehicle window comprises:
sensing a biometric reaction by the vehicle occupant responsive to the light source.

18. The vehicle control unit of claim 14 wherein the direction of a vehicle occupant gaze is based on:
a vehicle seat sensor device to indicate the position of the occupant relative to the vehicle window.

19. (canceled)

20. (canceled)
